(19) United States
(12) Patent Application Publication
(10) Pub. No.: US 2016/0068263 A1
(43) Pub. Date: Mar. 10, 2016

(54) FLAPPING WING DEVICE

(71) Applicant: NEW YORK UNIVERSITY, New York, NY (US)

(72) Inventors: Leif Ristroph, New York, NY (US); Stephen Childress, New York, NY (US)

(73) Assignee: NEW YORK University, New York, NY (US)

(21) Appl. No.: 14/785,609

(22) PCT Filed: Apr. 18, 2014
(86) PCT No.: PCT/US2014/034707

§ 371 Date: Oct. 19, 2015

Related U.S. Application Data
(60) Provisional application No. 61/814,031, filed on Apr. 19, 2013.

(51) Int. Cl. B64C 33/02

(52) U.S. Cl. CPC B64C 33/02

(57) ABSTRACT

A flapping wing device may include a main body and several wings hingedly coupled to the main body. The wings may be configured to reciprocate or “flap” relative to the main body to provide lift for the flapping wing device. A motor and trans mission, such as a crankshaft, are used to drive the reciprocating motion of the wings. The wings reciprocate from a first position that is substantially vertically parallel to the main body of the device to a second position in which a second end, opposite the hinged end, extends away from the main body. The motion of the reciprocating wings may be reminiscent of the motion of a jellyfish. In some instances, a first set of opposing or alternating wings may be reciprocated at an offset period relative to a second set of opposing or alternating wings, such as a quarter period offset.

### CROSS REFERENCE TO RELATED APPLICATION

This application claims the benefit of U.S. Provisional Application No. 61/814,031, entitled “Flapping Wing Device,” filed Apr. 19, 2013, the disclosure of which is incorporated by reference herein in its entirety.

### BACKGROUND

Unmanned air or aerial vehicles (“UAV”s) may range from large scale vehicles to miniature or micro UAVs. In attempting to reduce the size of micro UAVs, the flight mechanisms of insects and birds have been used as inspiration to design miniature maneuverable UAVs. Driven by this goal to reverse-engineer nature's flyers, rapid progress has occurred in the understanding of the aerodynamics of flapping wings as well as the behavioral aspects of insect flight. However, stabilization of flapping-wing aircraft presents unique challenges including unsteady aerodynamics, small length-scales, and fast time-scales.

To investigate and resolve these challenges, attempts to construct hovering ornithopters, or flapping-wing aircraft, have taken the biomimetic approach that aims to imitate the wing motions of insects. Some designs have mimicked so-called “normal hovering,” which is the mode employed by many animals including flies, bees, moths, and hummingbirds. During such normal hovering, wings are flapped back-and-forth in a horizontal stroke-plane and rapidly flipped over at each stroke reversal. The aerodynamics of these motions have been clarified by scaled experiments and flow simulations, including studies that indicate that the normal hovering mode induces an intrinsic instability in body orientation. Accordingly, to maintain an upright orientation, these insects require sophisticated sensory-motor systems that provide active modulation of flight forces. Aerial vehicles attempting to mimic such “normal hovering” techniques have also been plagued by the intrinsic instability in body orientation and can rapidly tumble from the air if left uncontrolled. Stabilizing these designs has demanded either the implementation of feedback control systems or the addition of tails or large sail-like surfaces that act as aerodynamic dampers.

The stability of a second mode of hovering—represented by the up-and-down flapping of the dragonfly—is less understood, though biomimetic designs appear to also rely on active control.

### SUMMARY

One implementation relates to an apparatus having a body, a wing hingedly coupled to the body at a first end, and a wing flapping mechanism coupled to the body and the wing. The wing has a first wing positions and a second wing position relative to the body. The first wing position being located near the body and the second wing position extending away from the body. The wing flapping mechanism is configured to reciprocally move the wing relative to the body from the first position to the second position.

Another implementation relates to an apparatus having a body, a motor fixedly attached to the body, a transmission coupled to the motor, and a plurality of wings. Each wing has a span from a first end to a second end. Each wing also has a chord-wise spar perpendicular to an axis defined by the span. Each wing is hingedly coupled to the body substantially near the first end, and the chord-wise spar of each wing is coupled to the transmission. The transmission is configured to reciprocally move each wing of the several wings relative to the body from a first position to a second position. Each wing is substantially vertically parallel to the body in the first position, and the second end of each wing is extended outwardly from the body such that the wing is not substantially vertically parallel to the body in the second position.

Yet another implementation relates to an apparatus having a body, a motor fixedly attached to a lower portion of the body, a crankshaft coupled to the motor, and a plurality of wings. The crankshaft is rotatable relative to the body by the motor. Each wing of the plurality of wings has a span from a first end of the wing to a second end and a chord-wise spar perpendicular to an axis defined by the span. Each wing is pivotably coupled to the body substantially at the first end and each chord-wise spar is coupled to a portion of the crankshaft. The crankshaft is configured to reciprocally mode each wing relative to the body from a first position to a second position. Each wing is substantially vertically parallel to the body in the first position and the second end of each wing is extended outwardly from the body such that the wing is not substantially vertically parallel to the body in the second position. The crankshaft is configured such that a first set of opposing wings of the plurality of wings reciprocate together and a set of opposing wings of the plurality of wings reciprocate together.

Additional features, advantages, and implementations of the present disclosure may be set forth from consideration of the following detailed description, drawings, and claims. Moreover, it is to be understood that both the foregoing summary of the present disclosure and the following detailed description are exemplary and intended to provide further explanation without further limiting the scope of the present disclosure claimed.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is an overview schematic drawing of an example flapping wing device having a single flapping surface;

FIG. 2 is a front elevation view of an example flapping wing device having four flapping wings;

FIG. 3 is a perspective view of an example body of the flapping wing device of FIG. 2;

FIG. 4 is a front elevation view of an example wing of the flapping wing device of FIG. 2;

FIG. 5 is a graphical view of the motion of an example wing and an example motion of a chord of the wing of the flapping wing device of FIG. 2 when the wing is driven at a low frequency;

FIG. 6 is a graphical view of the motion of an example wing and an example motion of a chord of the wing of the flapping wing device of FIG. 2 when the wing is driven at an off-center point of the chord at a high frequency and low amplitude;

FIG. 7 is a graphical view of the motion of an example wing of the flapping wing device of FIG. 2 when the wing is driven at an off-center point of the chord at a high frequency and high amplitude;

FIG. 8 is a graphical view of torque-frequency curves of an example motor for several applied voltages;

FIG. 9 is a graphical view of lift generated by the flapping wing device of FIG. 2 relative to motor voltage and of frequency relative to voltage;

FIG. 10 is a graphical view of lift coefficient of the flapping wing device of FIG. 2 relative to frequency;

FIG. 11 is a graphical view of a path of the flapping wing device of FIG. 2 during an ascent;

FIG. 12 is a graphical view of a path of the flapping wing device of FIG. 2 during forward flight;

FIG. 13 is a graphical view of a path of the flapping wing device of FIG. 2 during hovering;

FIG. 14 is a graphical view of the tilt of the flapping wing device of FIG. 2 relative to the vertical axis over time for a top-heavy configuration and a bottom-heavy configuration; and

FIG. 15 is a graphical view of the tilt of the flapping wing device of FIG. 2 relative to the vertical axis relative to horizontal speed of the flapping wing device of FIG. 2.

It will be recognized that some or all of the figures are schematic representations for purposes of illustration. The figures are provided for the purpose of illustrating one or more embodiments with the explicit understanding that they will not be used to limit the scope or the meaning of the claims

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

Described herein are devices and apparatuses that are adapted to fly through the use of flapping wings. The devices are capable of stable hovering flight using flapping wings alone, without the need for feedback control and without additional sails, tails, or other aerodynamic dampers. Such a minimalistic design may be useful to further scale down micro UAVs, robots, or other flying vehicles as implementing control systems may be increasingly challenging on smaller scales and damping surfaces may undermine both miniaturization and/or maneuverability. The devices described herein may be useful for achieving stable flapping-wing flight, a capability that could prove useful for several applications. For example, a stable flapping-wing flight capable device may be utilized for surveillance and/or reconnaissance, such as in a building, outdoors, in a mineshaft, in caves, etc. In other examples, the stable flapping-wing flight capable device may be used to monitor air quality in a particular region by utilizing sensors. In yet further examples, the stable flapping wing flight capable device may be used as a toy, a vehicle, or a swimming device. Of course, many other uses for a stable flapping-wing flight capable device may be implemented as well.

FIG. 1 depicts an example device 100 having a frustoconical surface 104 extending downwardly from a central body 102 and revolved about a central axis 101 such that the frustoconical surface 104 forms a uniform continuous surface. The central body may include a rigid or semi-rigid structure. The frustoconical surface 104 may include an elastomeric material or other material that is semi-rigid, but capable of stretching. The frustoconical surface 104 is hingeably coupled to the central body 102 such that the frustoconical surface 104 may reciprocally move such as to open and close (e.g., in a flapping motion) the defined frustoconical shape, as shown by the dashed lines 106, 108 and movement arrow 110. When the frustoconical surface 104 is opened (e.g., moves away from the central axis 101 and about the hinged coupling to central body 102) to a position shown by dashed lines 106 and then closed (e.g., moves towards the central axis 101 and about the hinged coupling to central body 102), a fluid, such as air or water, may be forced downwardly away from the central body 102. Thus, the device 100 may propel itself vertically and/or maintain a vertical altitude by reciprocally flapping the frustoconical surface 104. Such a motion is reminiscent of swimming jellyfish.

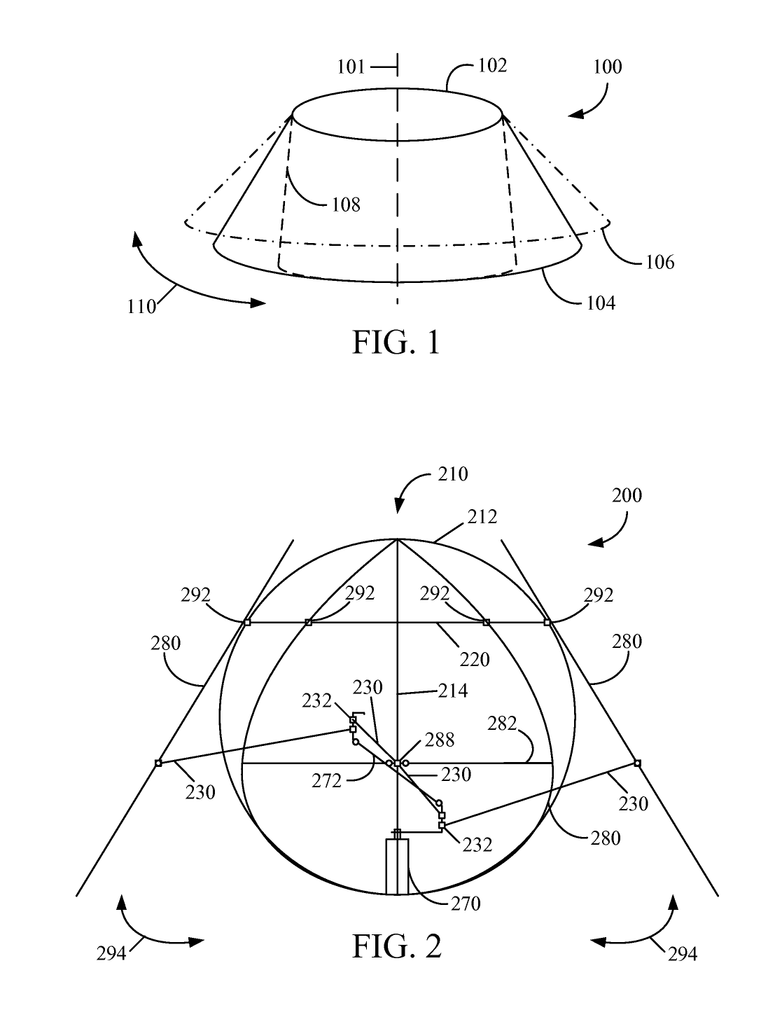

Referring to FIG. 2, an example flapping wing device 200 includes a main body 210 and a set of four wings 280. Each wing 280 of the set of four wings 280 is hingedly coupled substantially at a first end of each wing 280 to the main body 210. Thus, each wing 280 is pivotable about a respective rotary joint 292 such that each wing 280 may pivot from a first wing position located near the main body 210 to a the second wing position extending away from the main body 210. Thus, each wing 280 may make a flapping-type motion relative to the main body 210. In the present example, four wings 280 are used, though it should be understood that three wings 280, two wings 280, a single wing 280, and/or more than four wings 280 may be used. For example, in one implementation, a single continuous wing may reciprocate, such as that shown in FIG. 1. Such a single wing may be an elastomeric wing that may stretch or an accordion-type structure to expand and contract.

The flapping wing device 200 also includes a wing flapping mechanism. The wing flapping mechanism may include a motor 270 coupled to a transmission, such as a crankshaft 272, that may drive the wings 280 inwardly and outwardly relative to the main body 210 as the crankshaft 272 rotates, as will be described in greater detail below. In some implementations, the wing flapping mechanism may control the amplitude of each wing 280 relative to the main body 210. That is, the configuration of the crankshaft 272 may control how far out each wing 280 extends from the main body 210 when in the second wing position (i.e., the angle formed between the wing 280 and the main body 210 when the wing 280 pivots about the rotary joint 292). In some instances, each wing 280 may also flex along a span of the wing 280. Such flexure may be based, at least in part, on a speed of the motor 270. In some implementations the wing flapping mechanism may include a controller and/or power source to control and/or power the motor 270. The details of example implementations of wings 280, main body 210, and the operation of the wing flapping mechanism will be described in greater detail below.

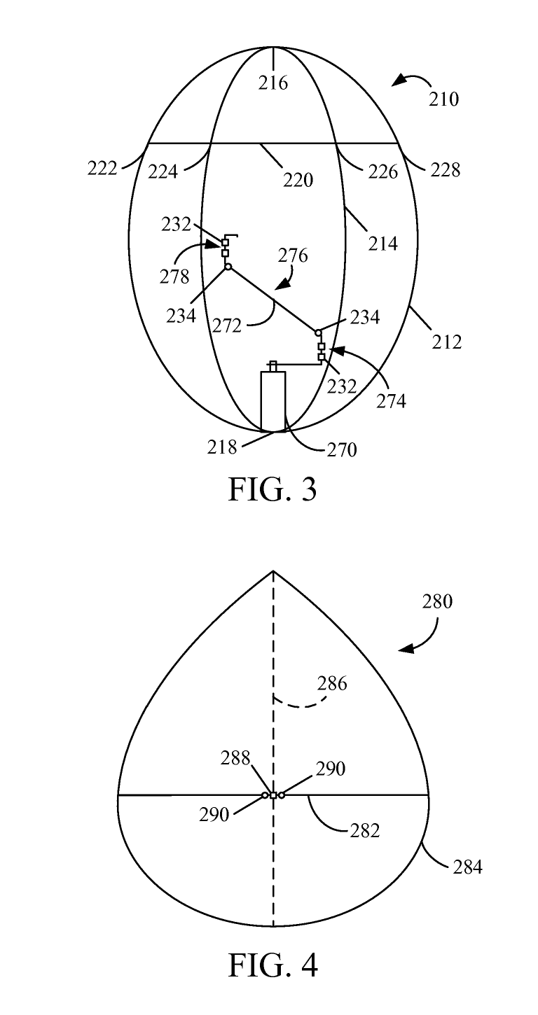

FIG. 3 depicts an embodiment having the main body 210, the motor 270, and the crankshaft 272 with the wings 280 removed and the main body 210 rotated to show a first loop 212 and a second loop 214. The first loop 212 and the second loop 214 are positioned such that the first loop 212 is perpendicular to the second loop 214 making a plus shape when viewed from the top. The first loop 212 and the second loop 214 are fixedly coupled together at intersections 216, 218 to form a rigid body. In one embodiment, the first loop 212 may be fixedly coupled to the second loop 214 via an adhesive (e.g., epoxy resin), mechanical couplings (bolts, screws, latches, hook and loop attachments, string, etc.), and/or any other method or configuration to fixedly couple the first loop 212 to the second loop 214.

In one embodiment, a third loop 220 is horizontally positioned at an upper portion of first loop 212 and second loop 212 to be used as a hinge or fulcrum portion for wings 280, as will be described in greater detail below. The third loop 220 is fixedly coupled to the first loop and the second loop at intersections 222, 224, 226, 228. In the present example, the third loop 220 is positioned at a distance below the intersection 216 of approximately 10% of the diameter of the first loop 212 and the second loop 214, though the position of the third loop 220 may be at any location relative to the intersection 216 and/or relative to and other portion of the main body 210. The third loop 220 may be fixedly coupled to the first loop 212 and the second loop 214 via an adhesive (e.g., epoxy resin), mechanical couplings (bolts, screws, latches, hook and loop attachments, string, etc.), and/or any other method or configuration to fixedly couple the third loop 220 to the first loop 212 and the second loop 214. In the present example, the first loop 212, second loop 214, and third loop 220 are made of carbon fiber. In some implementations, the loops 212, 214, 220 may be formed from other materials, including, but not limited to, aluminium, titanium, fiberglass, balsa wood, and/or any other rigid or semi-rigid material. Loops 212, 214, 220 thus form a skeleton, in one embodiment a spherical skeleton, of main body 210. Of course, it should be understood that loops 212, 214, 220 are merely examples and other configurations for the main body 210 may be utilized. For example, additional loops may be provided to provide additional rigidity and/or provide additional structure to attach devices to the main body 210. In other implementations, other geometric shapes for the main body 210 may be used. For instance, main body 210 may have geometric configuration of a tetrahedron, cube, cuboid, ovoid, cone, cylinder, other polyhedra, and/or any other geometric configuration.

In the present example, the motor 270 is fixedly coupled to the main body 210 at the intersection 218 and sits low on the main body 210. The weight of the motor 270 relative to the weight of the rest of the main body 210 results in the center of gravity of the flapping wing device 200 being located at a low, centered position of the main body 210. As will be described below, such a “bottom-heavy” configuration provides a corrective stabilizing force for both longitudinal and lateral stability if the flapping wing device 200 is pitched or rolled. The motor 270 of the present example is a GM 15 planetary gear motor available from Solarbotics Ltd., 3740D 11A Street NE Ste. #101, Calgary AB T2E 6M6, Canada. It should be understood that other motors may be utilized.

A crankshaft 272 is coupled to the motor 270. In one embodiment, the crankshaft 272 comprises a bent rigid structure having a first portion 274 and a second portion 278 connected by an intermediate portion 276. The crankshaft 272 of the present example comprises a semi-rigid material that may be bent or otherwise adjusted such that the position of the first portion 274 relative to the second portion 278 may be adjusted. Such adjustment will be described in greater detail below. Of course, in some implementations, the crankshaft 272 may be a rigid material such that the position of the first portion 274 relative to the second portion 278 may not be adjusted. It should be understood that crankshaft 272 is merely an example transmission to flap the wings 280 of the flapping wing device 200. In other implementations, motors 270 may be coupled to each wing 280 such that an individual motor 270 may flap a single wing 280. In other implementations, other transmission components may be implemented, such as a vertically oscillating ring on a shaft that is coupled to the wings 280 and cause the wings to flap (e.g., similar to an umbrella). Of course, still other transmissions to cause the wings 280 to flap may be implemented and the crankshaft 272 is merely one example.

In one embodiment, the crankshaft 272 is configured to couple to four link spars 230 (shown in FIG. 2) that, in turn, each couple to a spar 282 of each wing 280 such that the motor 270 may move the wings 280 when the shaft of the motor 270 is rotated. In the present example, the crankshaft 272 is configured such that a first opposing pair of wings 280 lead a second pair of opposing pair of wings 280 by a quarter period when opening and closing the wings 280 relative to the main body 210. The configuration of the crankshaft 272 will be described in greater detail below.

In one embodiment, the crankshaft 272 further includes rotary joints 232 that are each coupled to a corresponding link spar 230. The rotary joints 232 are retained within a corresponding portion 274, 278 of the crankshaft 272 via a perpendicular bend in the crankshaft 272 and a retaining member 234. In the present example, the rotary joints 232 each comprise a low-friction polytetrafluoroethylene (PTFE) tube (e.g., Teflon® made by Dupont™) that fits around crankshaft 272 such that the rotary joint 232 may rotate about crankshaft 272. Of course, other tubing and/or other rotary joints 232 may be implemented and the foregoing is merely an example. The rotary joints 232 are fixedly coupled to a respective link spar 230, such as via adhesive or other coupling, such that each link spar 230 may be pushed outwardly or pulled inwardly based upon the rotational position of the crankshaft 272.

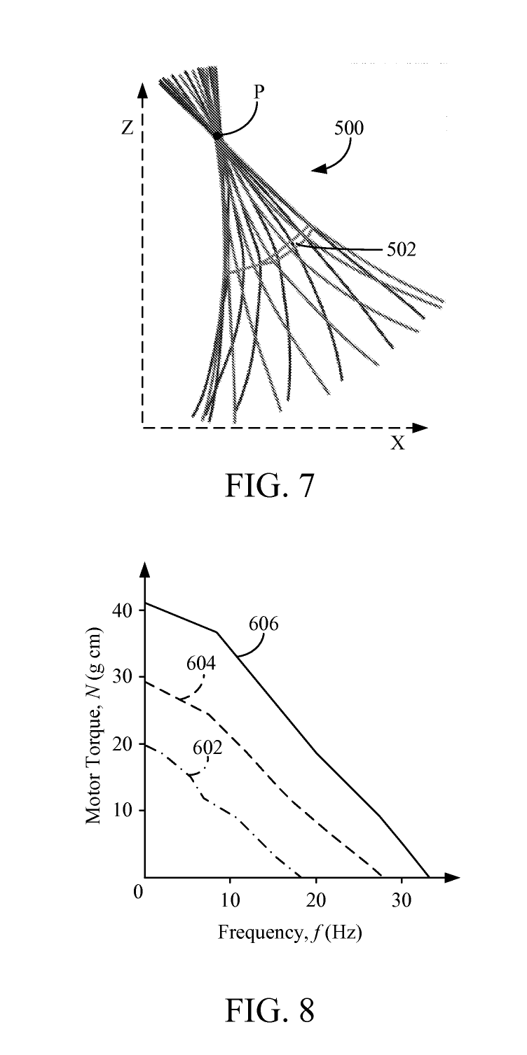

Referring to FIG. 4, an example wing 280 is depicted having an outer frame 284 and a chord-wise spar 282. In the present example, each wing 280 has a span of 8 cm, though other sizes may be used as well. Small wings 280 may be flapped at higher frequency but may have reduced lift due to a smaller area. Large wings 280 may have a larger area to increase lift, but may be flapped at a lower frequency, which may be power-limited by the motor 270, as will be discussed below. The outer frame 284 and the chord-wise spar 282 are made of carbon fiber, in one embodiment. In some implementations, the frame 284 and/or spar 282 may be formed from other materials, including, but not limited to, aluminium, titanium, fiberglass, balsa wood, and/or any other rigid or semi-rigid material. It should be understood that the teardrop shape of the wing 280 is merely an example and other aerodynamic wing profiles may be utilized. In the present example, a thin mylar film is coupled to the outer frame 284 such that the film covers the wing 280. In other implementations, other materials may be used to cover the wing 280, such as polyethylene terephthalate (such as Dacron®), heat shrinkable plastic films, etc. In the present example, the spar 282 is positioned at approximately a midpoint between a pair of rotary joints 292 pivotably coupling the wing 280 to the third loop 220 and a second end of the wing 280, though the position of the spar 282 may be at any other location of the wing 280. The spar 282 includes a wing rotary joint 288 and a pair of retaining members 290 coupled to the spar 282 such that the rotary joint 288 maintains a substantially constant position on the spar 282. The rotary joint 288 may comprise a low-friction polytetrafluoroethylene (PTFE) tube (e.g., Teflon® made by Dupont™), though other materials may be used as well. In the present example, the rotary joint 288 is shown centered on a span-wise axis 286. In some implementations, the retaining members 290 and the rotary joint 288 may be slid or otherwise repositioned on the spar 282. For example, the rotary joint 288 and retaining members 290 may be positioned such that the rotary joint 288 and retaining members 290 are offset from span-wise axis 286, an example of which will be described in greater detail below in reference to FIGS. 6-7.

Referring back to FIG. 2, each of the four wings 280 is hingedly coupled at or substantially near a first end of the wing 280 to the third loop 220 of the main body 210 via a pair of rotary joints 292 such that each wing 280 may pivot about the third loop 220 (e.g., in the manner shown by arrows 294). As noted above, each spar 282 of each wing 280 is coupled to a link spar 230 that is fixedly coupled to the rotary joint 288 of a corresponding wing 280 and a corresponding rotary joint 232 of the crankshaft 272. In the present example, the crankshaft 272, link spars 230, and wing spars 282 are configured such that, when the motor 270 rotates the crankshaft 272, a first pair of opposing wings 280 extends outwardly away from the main body 210 and a second pair of opposing wings 280 lags behind by an offset, such as a quarter period. As the crankshaft 272 continues to rotate, the first pair of opposing wings 280 reaches an apex of their motion (e.g., a maximum extension away from the main body 210) and then are pulled back in towards the main body 210. The second pair of opposing wings 280 similarly reaches an apex a quarter period behind the first pair of opposing wings 280 and are then pulled back in towards the main body 210. Thus, the first pair of opposing wings 280 reciprocates together and the second pair of opposing wings 280 reciprocates together, with the reciprocation of the first pair offset from the reciprocation of the second pair by a quarter period. In some instances, more than a pair of opposing wings 280 may be implemented, such as three wings for a first set of alternating wings and three wings for a second set of alternating wings. In some other implementations, other offsets for the reciprocating motion may be used, such as an eighth period, a sixth period, a half period, and/or any other offset. In one example implementation, the four wings 280 move in synchrony such that the four wings 280 reciprocate in and out relative to the main body 210 together.

It should be understood that, in one embodiment, the wings 280 move from a first position, in which the wings are substantially vertically parallel to a vertical axis of the main body 210, to a second position, in which the second end of each wing is extended away from the main body 210 such that the wing is not substantially vertically parallel to the main body 210 while the first end is hingedly coupled to the third loop 220. In the second position, the wing 280 may form an acute angle relative to a vertical axis of the main body 210. Accordingly, the wings 280, via the crankshaft 272 and link spars 230, flap relative to the main body 210 using rotary joints 292.

In some implementations, a power source for the motor 270, such as a battery, may be mounted to the main body 210. In other instances, the power source for the motor 270 may be remote from the device and coupled to the motor 270 via wires. In some implementations, a camera or sensors may be coupled to the main body 210. The camera or sensors may be coupled to a radiofrequency transceiver or transmitter to transmit data to a remote location. In other implementations, a storage device, such as a flash drive or other computer-readable medium may be mounted to the main body 210 such that the data from the camera or sensors may be locally stored.

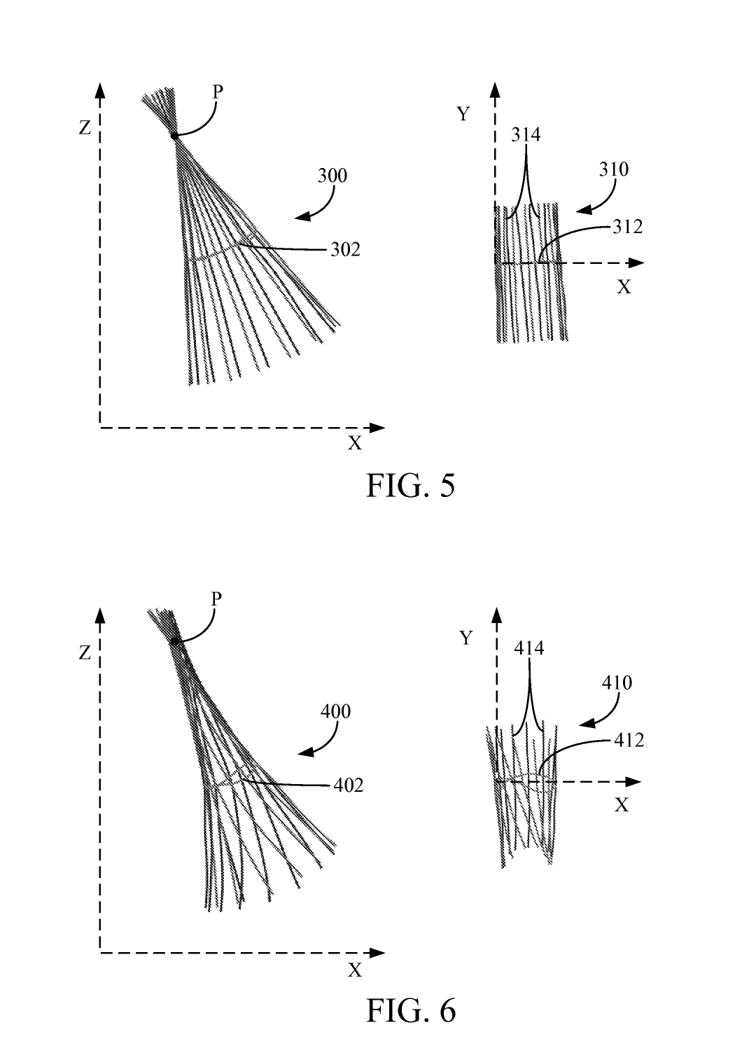

Referring to FIG. 5, a graphical representation of the movement of a wing 280 of the flapping wing device 200 in the span-wise plane is shown by representation 300 at a low voltage for the motor 270. In the present example, a low voltage is selected for the motor 270 that results in a low flapping frequency of 5 Hz. The wings 280 reciprocally oscillate in and out pivoting about point P, which corresponds to the hinged attachment point for the wing 280 to the third loop 220 via rotary joint 292, as shown by representation 300. Here, a dark trajectory line 302 represents the rotary joint 288-link spar 230 connection point at which the wing 280 is driven. A graphical representation of the movement of a wing 280 of the flapping wing device 200 in the chord-wise plane is also shown by representation 310 at a low voltage for the motor 270. The dark trajectory line 312 also represents the rotary joint 288-link spar 230 connection point at which the wing 280 is driven. Lines 314 represent the movement of the spar 282 of a wing 280.

Referring to FIG. 6, a graphical representation of the movement of a wing 280 of the flapping wing device 200 in the span-wise plane is shown by representation 400 at a higher voltage for the motor 270. In the present example, a higher voltage is selected for the motor 270 that results in a higher flapping frequency of 20 Hz. As shown, a portion of the wing 280 flexes along the span during both half-strokes. The present example also shows the motion of the wing 280 at a low amplitude. The amplitude of the flapping motion of the wings 280 may be increased or decreased by moving the position of the second portion 278 of the crankshaft 272 relative to the first portion 274 (e.g., by bending the crankshaft 272). Another dark trajectory line 402 represents the rotary joint 288-link spar 230 connection point at which the wing 280 is driven. A graphical representation of the movement of a wing 280 of the flapping wing device 200 in the chord-wise plane is also shown by representation 410. The dark trajectory line 412 also represents the rotary joint 288-link spar 230 connection point at which the wing 280 is driven. In the present example, the rotary joint 288 is offset from the span-wise axis 286, which results in a sculling type motion shown by the movement of lines 414.

FIG. 7 is a graphical representation of the movement of a wing 280 of the flapping wing device 200 in the span-wise plane is shown by representation 500 at the higher voltage for the motor 270 of FIG. 6 and at a higher amplitude than that shown in FIG. 6. In the present example, a higher voltage is selected for the motor 270 that results in a higher flapping frequency of 20 Hz. As shown, a portion of the wing 280 flexes along the span during both half-strokes. The amplitude of the motion of the wing 280 is increased compared to that shown in FIG. 6 by moving the position of the second portion 278 of the crankshaft 272 relative to the first portion 274 (e.g., by bending the crankshaft 272). A dark trajectory line 502 represents the rotary joint 288-link spar 230 connection point at which the wing 280 is driven.

As noted above, the span-wise dimension of the wings 280 may be determined by the power provided by the motor 270. This trade-off can be characterized by the torque-frequency curve of the motor 270. FIG. 8 depicts torque-frequency curves 602, 604, 606 for several voltages for a GM 15 planetary gear motor available from Solarbotics Ltd. Curve 602 corresponds to a voltage of 3.0 volts. Curve 604 corresponds to a voltage of 4.5 volts. Curve 606 corresponds to a voltage of 6.0 volts. For a given voltage, the motor 270 delivers maximum power when running at about half of its maximum speed. At 6.0 V, for example, the motor 270 operates most effectively when spinning at frequency fₘ˜17 Hz and delivering Nₘ˜25 g·cm of torque. A value for the wing size, R, will lead to flapping at fₘ, with the motor torque balancing the aerodynamic torque, Nₘ=Nₐₑᵣₒ˜ρfₘ²R⁵. Here, ρ is the density of air, and the torque is derived from the scaling of aerodynamic forces at a high Reynolds number (e.g.,

$$Re = \frac{ρ {fR}^{2}}{μ} ∼ {10}^{4} ,$$

where μ is the viscosity of air). Thus for the motor 270 of the present example, a wing length, R, may be predicted to be

$$R ∼ {( \frac{{N}_{m}}{ρ {f}_{m}^{2}} )}^{\frac{1}{5}} ∼ 10 cm .$$

More generally, this reasoning shows how the size of the wings 280 for a flapping wing device 200 may be determined by the characteristics of the chosen motor 270.

Lift for the flapping wing device 200 may also be determined by

$$L ∼ ρ {f}^{2} {R}^{4} ∼ {( ρ {f}_{m}^{2} {N}_{m}^{4} )}^{\frac{1}{5}} .$$

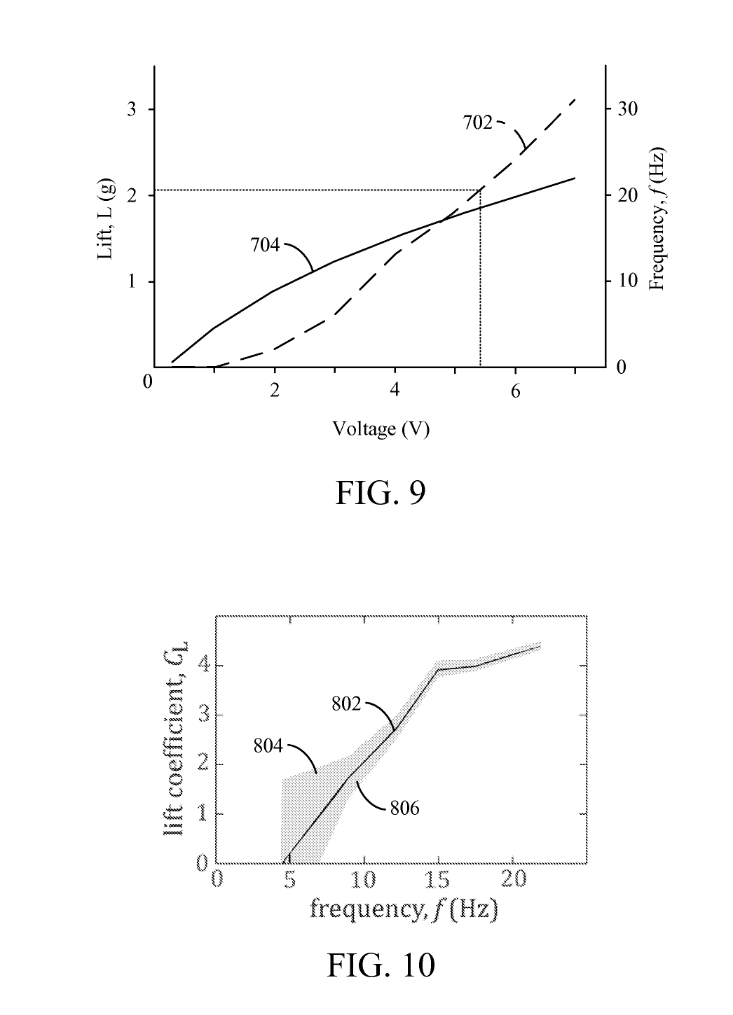

In the present example, the body weight of the flapping wing device 200, including the motor 270, is approximately 2.1 grams with the motor 270 having a body mass of 1.1 grams. The lift that is capable of being produced is several grams such that the motor 270 is capable of balancing a body weight of the flapping wing device 200 of several grams as well. FIG. 9 depicts an average lift curve 702 and flapping frequency curve 704 relative to increasing voltage. In the present example, a voltage near 5.5 volts leads to a frequency of approximately 21 Hz and a lift force of approximately 2.1 g, sufficient to support body weight of the flapping wing device 200.

The force generation capability can be further assessed by the lift coefficient,

$${C}_{L} = \frac{L}{0.5 ρ {w}^{2} S} ,$$

where w is the wing speed at its driving point (e.g., at the rotary joint 288) and S is the total wing area (e.g., the area covered by Mylar in the present example). Changes in C_{L} reflect changes in lift beyond what would be expected by conventional aerodynamics of rigid wings. As shown in FIG. 10, C_{L} increases with frequency as shown by curve 802, indicating increased performance as the wings 280 are driven faster. Such enhanced lift may be due in part to the increased amplitude associated with span-wise wing bending. Areas 804, 806 indicate a ±0.05 gram error in force measurement.

In some implementations, the flapping wing device 200 may be trimmed such that an equilibrium of spin and tilt torques may be achieved. An equilibrium of the spin and tilt torques may be useful to keep the flapping wing device 200 from rapidly spinning and tumbling over. Such equilibrium may be achieved through trial and error and/or otherwise. For example, if the flapping wing device 200 tends to tilt one way, the flapping amplitude of the wing 280 or wings 280 on this side may be increased. This amplitude adjustment may be accomplished by bending up or down the second portion 278 of the crankshaft 272, as shown in FIG. 2. In some implementations, the trimming may be automatically performed, such as via real-time feedback from on-board sensors and a servo or other motor that may adjust crankshaft 272 and/or wings 280 to adjust the amplitude. In other implementations, the trimming may be performed remotely, either manually or automatically, and transmitting the control data to a transceiver or transmitter coupled to the servo or other motor. Similarly, if the flapping wing device 200 tends to spin, the chord-wise motion may be adjusted to generate a compensating torque. Specifically, the sculling motions shown in FIG. 6 may be induced by sliding the rotary joint 288-link spar 230 connection point along the spar 282 of a wing 280. In some implementations, the trimming may be automatically performed, such as via real-time feedback from on-board sensors and a servo or other motor that may adjust the position of the rotary joint 288-link spar 230 connection and/or wings 280 to adjust the sculling motion. In still other implementations, the trimming may be performed remotely, either manually or automatically, and transmitting the control data to a transceiver or transmitter coupled to the servo or other motor.

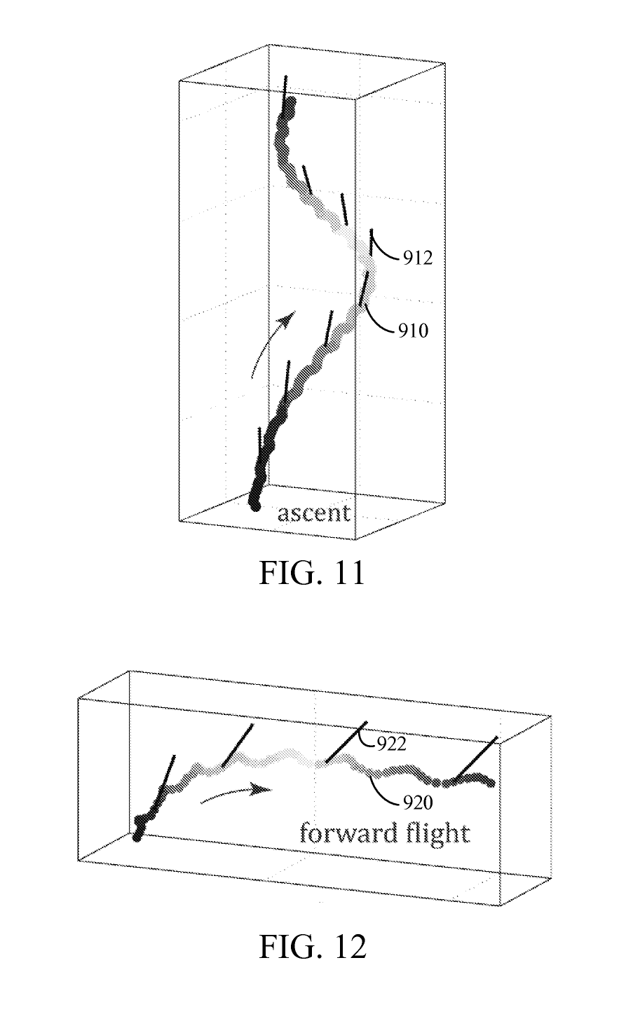

FIGS. 11-13 depict example flight paths 910, 920, 930 for the flapping wing device 200. Markers may be added to the main body 210 such that the motion of the flapping wing device 200 may be captured using a high speed camera. Two views may be captured on high-speed video and the markers may be tracked. A determination of the body center-of-mass position and tilt orientation may be made and the resulting flight paths 910, 920, 930 may be generated. In the example shown in FIG. 11, an ascending flight path 910 of the body and tilt orientation (shown by lines 912) is shown when a high voltage is applied to the motor 270 such that the lift generated from the wings 280 is greater than the body weight of the flapping wing device 200. Small oscillations represent undulations within a wing-beat, and the helical or spiral-like trajectory may be due to imperfect trimming.

FIG. 12 depicts an example forward flight path 920 of the body and tilt orientation (shown by lines 922). The forward flight path 920 may be achieved by increasing the flapping amplitude of the wings 280 on one side of the flapping wing device 200. Such an increase causes the flapping wing device 200 to tilt over and fly in a directed path in the horizontal plane. In the example shown, the flight path 920 depicts the flapping wing device's 200 trajectory as it transitions to steady forward flight with a tilt angle of approximately 35 degrees. Thus, navigation and control of the flapping wing device 200 may be implemented through control of the amplitude of the wing motion. In addition, the flapping wing device 200 has a tendency to maintain upright orientation during maneuvers.

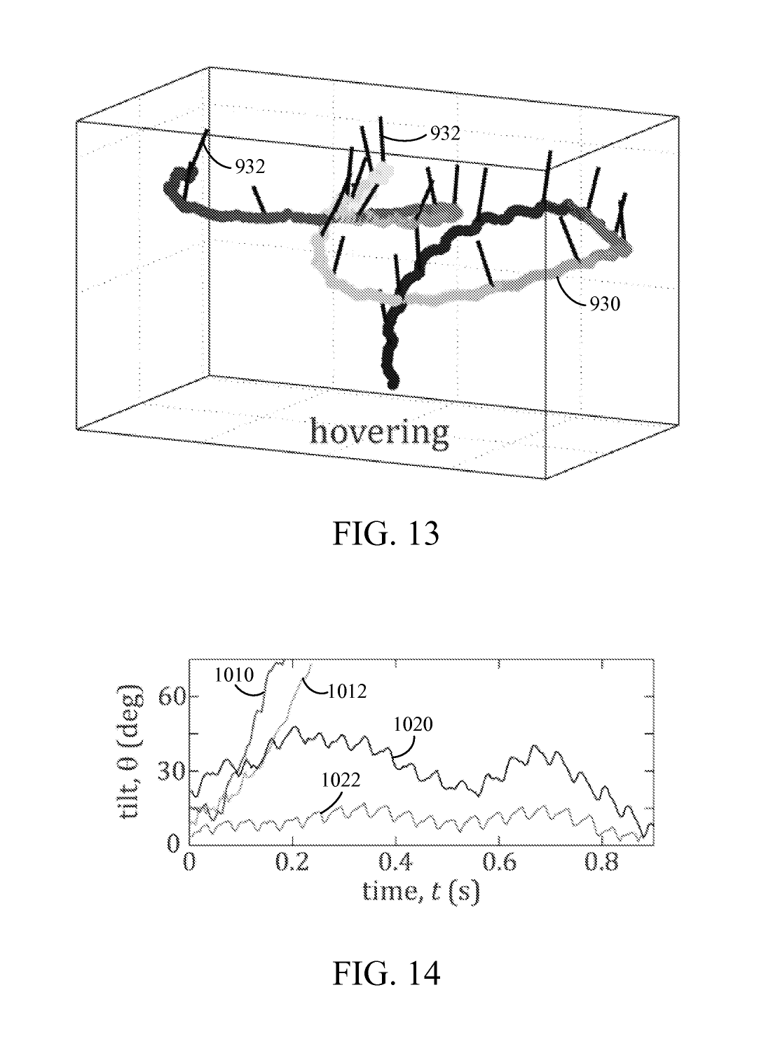

FIG. 13 depicts an example hovering flight path 930 of the body and tilt orientation (shown by lines 932) by trimming spin and tilt for the flapping wing device 200 and setting the voltage for the motor 270 to approximately just over 5.5 volts. In the flight path 930 example shown, once powered, the flapping wing device 200 rises upwards for several wing-beats and then maintains a relatively constant height while meandering in the horizontal plane. As shown in the example, the flight path 930 is marked by sequences in which the flapping wing device 200 slightly tilts to one side and translates in that direction before returning to a near upright posture. The succession of these runs and loops leads to an erratic path reminiscent of the fluttering flight of a moth.

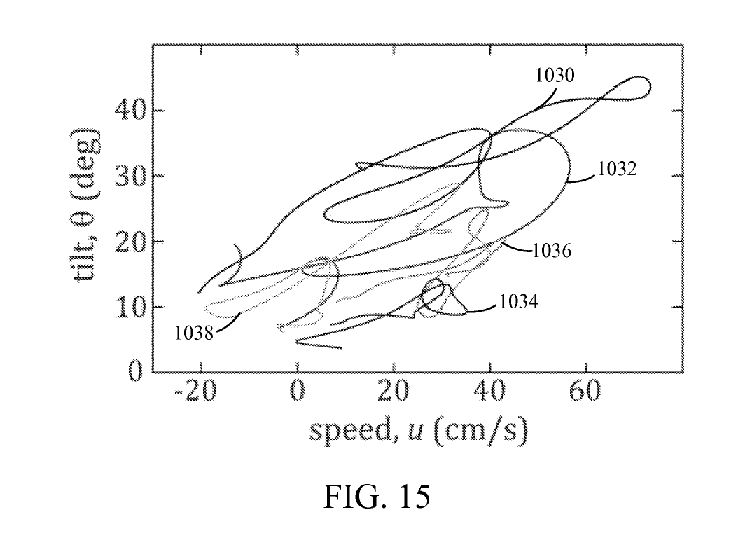

FIG. 14 depicts the tilt of the flapping wing device 200 over time during a hovering flight path 930. In the example shown, curves 1010, 1012 depict the tilt orientation relative to a vertical axis over time for a flapping wing device 200 having the motor 270 attached at an upper portion of the main body 210 (e.g., at the top intersection of the first loop 212 and the second loop 214). This top-heavy version rapidly tumbles over when released, as revealed shown by the rapid increase in tilt angle θ over a short period of time. Curves 1020, 1022 depict the tilt orientation relative to a vertical axis over time for a flapping wing device 200 having the motor 270 attached to the main body 210 as shown in FIG. 2. The flapping wing device 200 recovers from excursions to large tilt angles, as shown by curves 1020, 1022. In the present example, the high-frequency fluctuations represent the motion within a wing-beat, while the slower undulations correspond to tilt-run-recover sequences. FIG. 15 depicts the variation of tilt angle θ relative to horizontal speed for five curves 1030, 1032, 1034, 1036, 1038 during hovering flight paths, such as hovering flight path 930. In the example shown, excursions to large tilt angles are associated with high horizontal velocity in that direction, followed by a return to a lower tilt angle and a lower velocity. Thus, as the flapping wing device 200 is tilted, the horizontal velocity increases, but the wings 280 incur increased drag, which opposes the horizontal velocity. In addition, the weight of the low positioned motor 270 is offset from the vertical axis, imparting countering torque on the flapping wing device 200. The countering torque urges the flapping wing device 200 back towards a vertical orientation, thereby reducing the tilt and the horizontal velocity. Such self-corrective motion of the flapping wing device 200 results in not needing to utilize feedback control systems or the addition of tails or large sail-like surfaces that act as aerodynamic dampers.

It should be understood that, while the foregoing example has described the flapping wing device 200 in reference to flight through air, the flapping wing device 200 may move or swim through other fluids, such as water.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. An apparatus comprising:
a body;
a wing hingedly coupled to the body substantially at a first end of the wing; and
a wing flapping mechanism coupled to the body and the wing;
the wing having a first wing position and a second wing position relative to the body, the first wing position located near the body and the second wing position extending away from the body;
wherein the wing flapping mechanism is configured to reciprocally move the wing relative to the body from the first position to the second position.

2. The apparatus of claim 1, wherein the wing is a first wing, the apparatus further comprising a second wing hingedly coupled to the body substantially at a second end of the second wing and coupled to the body opposite the first wing.

3. The apparatus of claim 2, wherein the wing flapping mechanism is configured to reciprocally move the first wing and the second wing substantially simultaneously.

4. The apparatus of claim 3 further comprising:
a third wing hingedly coupled to the body substantially at a third end of the third wing,
wherein the wing flapping mechanism is configured to reciprocally move the third wing relative to the body a period of time after reciprocally moving the first wing and second wing.

5. The apparatus of claim 4, wherein the period of time a quarter period.

6. The apparatus of claim 4, wherein the wing flapping mechanism comprises:
a motor fixedly attached to the body, and
a transmission coupled to the motor,
wherein the transmission is configured to reciprocally move the first wing, the second wing, and the third wing relative to the body.

7. The apparatus of claim 6, wherein the motor is fixedly attached substantially at a lower portion of the body to self-correct tilt of the apparatus.

8. The apparatus of claim 6, wherein a wing dimension of one of the first wing, the second wing, or the third wing is based on a characteristic of the motor.

9. The apparatus of claim 8, wherein the characteristic is a torque-frequency curve of the motor.

10. The apparatus of claim 1 further comprising one of a camera, a sensor, a storage device, or a transmitter.

11. The apparatus of claim 1, wherein the wing flapping mechanism is configured to control an amplitude of the second wing position relative to the body.

12. An apparatus comprising:
a body;
a motor fixedly attached to the body;
a transmission coupled to the motor; and
a plurality of wings, each wing of the plurality of wings having a span from a first end of the each wing to a second end, each wing having a chord-wise spar substantially perpendicular to an axis defined by the span, each wing hingedly coupled to the body substantially near the first end, and the chord-wise spar of each wing coupled to the transmission;
wherein the transmission is configured to reciprocally move each wing of the plurality of wings relative to the body from a first position to a second position, wherein each wing is substantially vertically parallel to the body in the first position, and wherein the second end of each wing is extended outwardly from the body such that the wing is not substantially vertically parallel to the body in the second position.

13. The apparatus of claim 12, wherein the motor is fixedly attached substantially at a lower portion of the body to self-correct tilt.

14. The apparatus of claim 12, wherein each wing of the plurality of wings is configured to flex along the span of each wing.

15. The apparatus of claim 14, wherein a flexure of each wing is based, at least in part, on a speed of the motor.

16. The apparatus of claim 12, wherein each wing comprises a carbon fiber frame and a film covering.

17. The apparatus of claim 12, wherein a coupling of each wing of the plurality of wings is configured to substantially equalize a spin or tilt torque.

18. An apparatus comprising:
a body;
a motor fixedly attached to a lower portion of the body;
a crankshaft coupled to the motor, the crankshaft rotatable relative to the body by the motor; and
a plurality of wings, each wing of the plurality of wings having a span from a first end of the wing to a second end, each wing having a chord-wise spar perpendicular to an axis defined by the span, each wing pivotably coupled to the body substantially at the first end, and each chord-wise spar of each wing coupled to a portion of the crankshaft;
wherein the crankshaft is configured to reciprocally move each wing of the plurality of wings relative to the body from a first position to a second position, wherein each wing is substantially vertically parallel to the body in the first position, and wherein the second end of each wing is extended outwardly from the body such that the wing is not substantially vertically parallel to the body in the second position;
wherein the crankshaft is further configured such that a first set of opposing wings of the plurality of wings reciprocate together and a second set of opposing wings of the plurality of wings reciprocate together.

19. The apparatus of claim 18, wherein the reciprocation of the first set of opposing wings is offset from the reciprocation of the second set of opposing wings by a quarter period.

20. The apparatus of claim 18 further comprising one of a camera, a sensor, a storage device, or a transmitter.
